(19) United States
(12) Patent Application Publication
(10) Pub. No.: US 2004/0099060 A1
(43) Pub. Date: May 27, 2004

(54) Device and method for characterizing a capillary system

(76) Inventors: Johan Kijlstra, Bergisch Gladbach (DE); Dipl.-Ing. Dieter Ruhle, Odenthal (DE); Ralf Neigl, Yorktown Heights, NY (US)

Correspondence Address: BAYER CORPORATION, 511 Benedict Avenue, Tarrytown, NY, 10591, US

(21) Appl. No.: 10/302,492

(22) Filed: Nov. 23, 2002

(51) Int. Cl. G01L 7/00

(52) U.S. Cl. 73/714

(57) ABSTRACT

The present invention relates to a device for characterizing a capillary system in terms of wettability and geometry. The capillary pressure related to the presence of a meniscus inside an capillary system between a liquid/gas or liquid/liquid interface is measured. The pressure measuring device is comprising

a capillary system,

a liquid pump for pumping liquid into and out of a capillary system,

a pressure sensor to measure the pressure of the liquid, and

a tubing system for connecting the liquid pump, the pressure cell and the capillary system.

The present invention relates to a device and a method to characterize a capillary system in terms of wettability and geometry by determining the liquid pressure, from which the capillary and/or viscous pressure can be deduced.

The term capillary system is generally defined as a system, which features, when in contact with a liquid, a meniscus or curved liquid/air interface. The curvature of this interface determines the pressure inside the liquid. Typical examples comprise capillaries, thin tubings, slits, microfluidic devices, powders and porous systems.

The capillary pressure is related to the presence of a meniscus (i.e. a liquid/gas or liquid/liquid interface) inside a capillary system. It refers to the pressure drop across this curved liquid interface. For an interface inside a capillary system, this curvature is not only closely related to the geometry of the capillary system, but also to the wettability of the surface at the border where the liquid and the solid meet (i.e. at the 3-phase contact line).

The spreading and wetting of fluids on solid surfaces or inside capillary systems is important in a wide range of industrial processes.

The viscous pressure refers to the pressure drop inside a flowing liquid due to viscous dissipation. For a capillary system completely or partially filled with a moving liquid, it is closely related to the geometry of the capillary system.

The measurement of the liquid pressure can be performed under static as well as under dynamic conditions. Under dynamic conditions, the liquid slowly flows in a controlled matter through the capillary system and displaces a gas or another non-miscible liquid. Depending on the measurement conditions, the capillary and viscous pressure can be obtained from the liquid pressure.

By measuring the capillary pressure with the method and device according to the invention, the spatial resolved wetting properties of the inner surfaces and/or the geometrical dimensions of the capillary system can be determined with high resolution.

By measuring the viscous pressure with the method and device according to the invention, the geometrical dimensions of the capillary system can be investigated.

Usually, the wettability of a solid is characterized by the contact angle which the liquid makes with the solid (measured through the liquid). Different angles can be experimentally obtained: i) static angles measured after advancing or receding the liquid front and ii) dynamic angles measured during the displacement of the liquid front. In practice, the advancing and the receding static angles usually differ. A variety of possible causes may explain this contact angle hysteresis, a.o. chemical or surface composition heterogeneity.

For flat surfaces, the contact angle is usually measured by optical imaging of a sessile drop on the surface. For capillaries, the static contact angles may be obtained by measuring the equilibrium height and/or dynamics of the capillary rise (or depression). Also optical imaging of the meniscus inside capillaries can be used to determine the meniscus curvature, from which the contact angle can be deduced. An overview of these and other currently known techniques for measuring contact angles is recently given by J. Lyklema (in Fundamentals of Interface and Colloid Science, Volume II, 2000, Academic Press).

A major disadvantage of all known techniques to determine contact angles and surface wettability is their lack of spatial resolution. The contact angle only characterizes the surface wettability at the border, where the liquid front and the solid meet. Static methods like the sessile drop and the capillary rise method probe therefore only very small portions of the surface area, since they do not allow systematic scanning of the surface area due to experimental or physical reasons. This is a serious drawback, since the quality and the applicability of many technical surfaces are often primarily determined by the degree of homogeneity of the surface and the lack of local defects and/or contamination. Consequently, non-destructive techniques to characterize the spatial resolved wettability of a surface and its heterogeneity are desired. Here, surface heterogeneity is defined when the local equilibrium contact angle θₜ is not everywhere the same.

Dynamic methods with moving liquid fronts which scan across the surface can be used to obtain information on the spatial resolved wettability. Many dynamic wetting methods have been published, but they all (having different objectives) do not provide this spatial information. Examples of such methods are for example given by Schaffer and Wong (on the capillary rise and fall technique, Physical Review E, 61, 5, 2000, 5257), by Stokes et al. (on the dynamic pressure response of interfaces in capillaries, J. P. Stokes, M. J. Higgins, A. P. Kushnick, S. Bhattacharya and M. O. Robbins, Physical Review Letters, 65, 15, 1990, 1885), and by Kumar (on the dynamic pressure response of interfaces in capillaries, S. Kumar, M. O. Robbins and D. H. Reich, Mat. Res. Symp. Proc. Vol. 407, 1996, 21) and by Hofmann (on the dynamic contact angle in capillaries, Journal of Colloid Interface Science, 50, 2, 1975, 228).

Hoffmann determines the shape of the meniscus by optical imaging to obtain the dynamic contact angle when the liquid advances slowly through a capillary and displaces a gas. In principle, this method could be extended to obtain spatial resolved information as well. Such an extended method would however suffer from many drawbacks, a.o. the method would only be suitable for transparent capillaries and it would require complex data analysis. The most important drawback is based on the imaging principle, i.e. by using 2-D pictures of the 3-D meniscus. If the meniscus shape deviates from a spherical surface, this conversion leads to a loss of information. Hence, Hoffman's method requires the meniscus shape to be spherical, demanding that the local contact angle along the perimeter (or 3-phase contact line) of the meniscus is everywhere the same. For many practical systems, this assumption is not very realistic, which seriously limits the applicability of this optical method.

The problem of assuming cylindrical symmetry can be circumvented by directly measuring the pressure inside the liquid. By doing so, the capillary pressure can be determined. This capillary (or Laplace) pressure AP can be written as a wetting factor, which is proportional to the line integral of the cosine of the local contact angle θₗ along the contact line (cl) of length L, divided by the cross section A of the capillary system. Hence, we have

$$Δ {P}_{L} = \frac{γ \cdot {\int }_{cl}^{} cos {θ}_{l} ⅆ x}{A} \qquad ( I )$$

where γ is the surface tension of the liquid. For a cylindrical capillary of radius r and a spherical shaped meniscus, A=π·r². For a slit capillary of width a, height b and length l, A=a·b. Therefore, the capillary pressure reflects the average wettability of the surface along the contact line.

Depending on the surface wettability and the geometrical dimensions of the capillary system, capillary pressures and/or changes thereof can be very low (<100 Pa). Small surface defects or contamination may even cause much smaller pressure changes (<5 Pa). Consequently, by measuring these very small pressure changes as a function of the position of the meniscus inside the capillary system, a non-destructive technique to characterize the spatial resolved wettability of the capillary surface and its heterogeneity can be developed.

A technique for direct measurement of the liquid pressure inside capillary systems, from which the capillary pressure can be obtained, has not been published yet. Kumar et al. (ref. see above) investigated the capillary pressure related to a moving meniscus inside a cylindrical capillary. However, they only developed a technique to measure the first and second derivative of the pressure with respect to the velocity of the meniscus, not to measure the capillary pressure itself (neither under the static or dynamic conditions). Moreover, their technique does not provide any spatial resolution. Despite previous attempts of Kumar et al. and others, a method for the direct measurement of the capillary pressure in a liquid has now been found.

The problem of the invention is to provide a device and a method for the characterization of a capillary system in terms of wettability and geometry by determining the liquid pressure and changes thereof with high resolution, from which the capillary and/or viscous pressure can be deduced.

A further problem is to provide a special resolved characterization of small tubes or capillaries.

The solution of this problem according to the invention is a pressure measuring device for characterizing the capillary pressure and/or wettability of a capillary system in terms of wettability at a resolution of at least 100 Pa, preferably at least 10 Pa, comprising

A) a liquid pump for pumping a measuring liquid through the capillary system,

B) a pressure sensor to measure the pressure of the measuring liquid, and

C) a tubing system connecting the liquid pump, and the pressure sensor cell with the capillary system.

A preferred measuring liquid is selected from water, alcohols, hydrocarbon, halogenated hydrocarbons or silicon oil.

Preferably the measuring liquid is free from surface active compounds.

Preferably the liquid pump is a hydrostatic pump. In contrast to mechanical pumps, a hydrostatic pump allows a precise regulation of the fluid flow in either direction, e.g. a perfect constant rate of displacement of the meniscus inside the capillary system.

The hydrostatic pump preferably comprises of a hydrostatic column in combination with a flow valve and a flow regulator. The flow regulator provides a viscous resistance, which determines the fluid flow for given hydrostatic column of height h (relative to the position of the capillary system).

The fluid flow rate D can be precisely controlled, if the pressure drop ΔP (fr) across the flow regulator is much larger than the sum of the absolute capillary pressure |ΔP_{L}| and the pressure drop ΔP_{f} due to the viscous resistance across the connecting tubing and the capillary system together, i.e.

ΔP(fr)>>ΔP_{f}+|ΔP_{L}|

Therefore, the choice of flow regulator and height difference h between hydrostatic column and capillary system depends on the properties of the latter. In the special case of a cylindrical capillary used as flow regulator, this requirement can be written as

$$\frac{{l}_{fr}}{{a}_{fr}^{4}} ⪢ \frac{{l}_{cs}}{{a}_{cs}^{4}}$$

$$and$$

$$ρ \cdot g \cdot h ⪢ \frac{2 \cdot γ}{{a}_{cs}}$$

where l_{fr} the length and a_{fr} the (effective) capillary radius of the flow regulator, respectively, a_{cs} and l_{cs} the corresponding parameters of the capillary system, h the height of the hydrostatic column, g the standard acceleration of free fall and p and g the density and surface tension of the liquid, respectively.

Preferably, the viscous resistance across the connecting tubing is much smaller than that across the capillary system. Therefore, the length and inner diameter of the connecting tubing should be chosen as small as possible but such that preferably

$$\frac{{l}_{cs} \cdot {a}_{ct}^{4}}{{l}_{ct} \cdot {a}_{cs}^{4}} > 5 ,$$

more preferred

$$\frac{{l}_{cs} \cdot {a}_{ct}^{4}}{{l}_{ct} \cdot {a}_{cs}^{4}} > 50$$

and even more preferred

$$\frac{{l}_{cs} \cdot {a}_{ct}^{4}}{{l}_{ct} \cdot {a}_{cs}^{4}} > 100 ,$$

where l_{cs} the length and a_{cs} the (effective) capillary radius of the connecting tubing, respectively, and a_{cs} and l_{cs} the corresponding parameters of the capillary system. Similar criteria also holds for the choice of other functional units (as described below), incorporated into the hydraulic system of the measuring device.

A differential pressure sensor is usually used for the measurements, although any other type of pressure sensors may be used as well. Pressures sensors with very high sensitivity are required. Such sensors for liquids are commercially not available, only for gases. Consequently, in order to enable an accurate measurement, a gas/liquid-interface has to be introduced into the system. This interface is positioned inside the sensor cell and determines the design of the sensor cell. In our invention, the differential sensor is used to measure the pressure difference ΔP between the air pressure ΔP_{S} inside the sensor cell and the atmospheric pressure ΔPₐₜₘ.

For a limited number of special applications with relative high liquid pressures, commercially available pressure sensors suitable for liquids may be used without the need for a gas/liquid-interface inside the sensor cell. This weakens the demands on the design of the sensor cell strongly.

Preferred is a pressure measuring device, characterised in that the pressure sensor is connected via a air tight pressure sensor cell to the tubing between flow regulator and capillary system.

A further preferred embodiment of the pressure measuring device is characterized in that pressure sensor measures the difference between the sensor cell pressure and the atmospheric pressure.

However, to enable the measurement of low pressures and changes thereof with high accuracy and therefore to enable the characterization of the surface wettability of capillary systems with high spatial resolution, the presence of the air/liquid interface inside the sensor cell is necessary. The sensor cell has to be designed as such that

1) the pressure drop across the air/liquid interface inside the sensor cell is constant and preferable as small as possible and that

2) a possible displacement of the entire meniscus inside the sensor cell (and consequently of the one inside the capillary system) due to pressure or temperature changes is minimized

This to avoid experimental problems related to presence of a flexible and displaceable interface inside the sensor cell. These problems comprise

i) pressure measurements artifacts and

ii) uncontrolled liquid flow out of the sensor cell into the capillary system or vice versa.

This uncontrolled liquid flow causes positioning errors of the air/liquid interface inside the capillary system.

Criterion 1 can be fulfilled by optimizing the surface properties of the inner walls of the sensor cell and by carefully choosing the radius of the sensor cell. The material of these inner walls have to be preferably chosen as such, that no contact line pinning of the air/liquid interface occurs. This requires low contact angle hysteresis H, defined as H=cos θ, −cos θₐ, where θ_{l a} and θᵣ are the advancing and receding static contact angle, respectively. Consequently, the wall material should preferably be chosen as such that H is as close to zero as possible, preferred less than 0,25, more preferred less than 0,15, even more preferred less than 0,05.

In order to minimize the pressure drop across the meniscus inside the sensor cell, both static contact angle and sensor cell dimensions can be adjusted. Preferably, the static contact angle of the measuring liquid with the sensor cell inner wall preferably approaches 90°. Alternatively, the radius of the sensor cell should be preferably adjusted as such, that

$$\frac{2 \cdot γ}{{a}_{cell}} ⪡ Δ P ,$$

with a_{cell} the (effective) radius of the sensor cell, γ the surface tension of the measuring liquid and AP the desired pressure resolution. If this condition can not be fulfilled (see below), then a_{cell} should be chosen larger than the capillary length κ of the measuring liquid defined by κ=\sqrt{γ/ρ·g}, where γ and ρ are the surface tension and the density of the measuring liquid, respectively, and g the gravity constant (or more precisely, the standard acceleration of free fall). Preferably a_{cell}>κ, more preferred a_{cell}>3·κ and even more preferred a_{cell}>5·κ. The maximum radius a_{cell} is limited due to criterion 2.

Criterion 2 can be fulfilled by choosing conditions that minimize displacement of the meniscus inside the sensor cell due to pressure and temperature changes. This can be achieved by i) by working under thermostated conditions and by ii) reducing the air volume Vₐᵢᵣ inside the sensor cell.

Further preferred is a pressure measuring device, wherein the sensor cell is thermostated.

Thermostating the air inside the sensor cell has shown to be essential for correct and precise measurement. The temperature change ΔT during measurement should be as small as possible, preferably ΔT<0,5K, more preferred ΔT<0,2K, and even more preferred ΔT<0,05K.

The volume Vₐᵢᵣ depends on the size of the sensor cell and the position of the meniscus inside this cell. It has to be adjusted depending on the dimensions of the capillary system and the desired spatial resolution Δx of the spatial resolved wetting properties, as defined above. Therefore, we define a critical air volume Vₐᵢᵣ^{c}

$${V}_{air}^{c} = \frac{π \cdot Δ x \cdot {a}_{cs}^{3} \cdot {P}_{atm}}{2 \cdot γ}$$

with Pₐₜₘ the atmospheric pressure. This critical volume determines the desired Vₐᵢᵣ and consequently, an upper limit for the size and the (effective) radius of the sensor cell. Preferably Vₐᵢᵣ<5·Vₐᵢᵣ^{c}, more preferred Vₐᵢᵣ<1·Vₐᵢᵣ^{c}, and even more preferred Vₐᵢᵣ<0,1·Vₐᵢᵣ^{c}.

In order to fulfill both criteria, a compromise regarding sensor cell size and the resulting air volume inside the sensor cell has to be made. This compromise depends on the size of the capillary system under investigation.

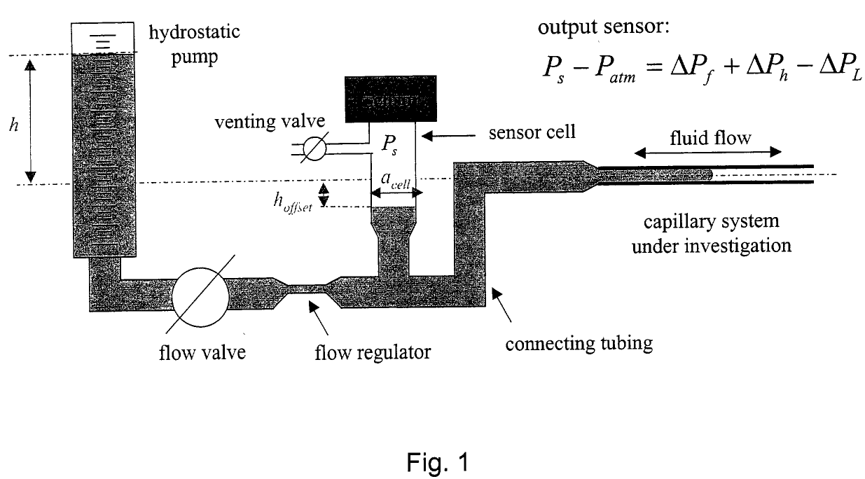

The pressure sensor cell with attached pressure sensor preferably should be air tight and positioned between the flow regulator and the capillary system according to FIG. 1. For high precision measurements at low capillary pressures, pressure sensor resolution should be preferably 1 Pa or less.

The flow can be stopped by closing a flow valve, which can preferably be introduced e.g. between hydrostatic pump and flow regulator according to FIG. 1.

Additional valves, tubings, connectors, height detectors or other functional units may be used to regulate the fluid flow and to calibrate the equipment.

EMBED

Another object of the invention is a method for characterizing a capillary system concerning capillary pressure and/or wettability comprising the steps providing a pressure measuring device described above by,

a) filling the pressure measuring device with a measuring liquid,

b) pumping this liquid from the pressure measuring device through the capillary system to fill or empty the capillary system with the measuring liquid and displacing a second phase, e.g. air, in the capillary system,

c) measuring the pressure difference ΔP=Pₛ−Pₐₜₘ (with P_{S} the sensor cell pressure and Pₐₜₘ the atmospheric pressure) under static or dynamic conditions,

d) eventually measuring or determining the pressure P₂ of the second phase which will be displaced when the measuring liquid flows through the capillary system,

e) measuring the hydrostatic contribution APh

f) measuring or determining the viscous contribution ΔPᵥ,

g) determining the capillary pressure APL according to formula (II),

Δ_{P}−=ΔPₕ+ΔPᵥ−ΔP+(P₂−Pₐₜₘ) (II)

h) interpretation of the capillary pressure APL in terms of wettability by using equation (I)

$$Δ {P}_{L} = \frac{γ \cdot {\int }_{cl}^{} cos {θ}_{l} ⅆ x}{A} \qquad ( I )$$

In order to perform a measurement, the device is completely or partially filled with the measuring liquid, which can be pumped into or out of the capillary system, displacing a gas or another non-miscible liquid. The pressure difference AP can be measured both under static (no fluid flow) or under dynamic (finite fluid flow) conditions.

To interpret ΔP, the pressure P₂ inside the second phase should be known and preferably constant. If the second phase is air of atmospheric pressure, P₂ equals Pₐₜₘ, which can be considered constant. If the second phase is a liquid, the pressure inside this liquid should be kept constant, e.g. by attaching a liquid reservoir at the back end of the capillary system. Preferably, this reservoir is open, i.e. in contact with the atmosphere. The (effective) radius aᵣ of this reservoir should be preferably aᵣ>3·κ, more preferred aᵣ>5·κ and even more preferred aᵣ>10·κ. The known height hᵣ of this reservoir should be preferably sufficiently large, so that i) it is much larger than the effective radius of the capillary system and ii) it does not significantly change during the measurement

If the measuring liquid displaces air with atmospheric pressure, then the pressure difference ΔP can be written as a sum of three contributions, i.e. ΔP=ΔPₕ+ΔP_{b}−ΔP_{L}. These different contributions can be differentiated from each other by choosing the experimental conditions adequately and by performing additional measurements.

If the measuring liquid does not displace a second phase with atmospheric pressure, then the pressure difference ΔP can be written as ΔP=ΔPₕ+ΔPᵥ−ΔP_{L}+(P₂−Pₐₜₘ).

Under static conditions (no fluid flow), this pressure difference ΔP can be written as a sum of capillary pressure ΔP_{L} and a hydrostatic contribution ΔPₕ.

The hydrostatic pressure contribution ΔPₕ can be quantified by measuring the hydrostatic offset hoffset defined as the height difference between the interface inside the sensor cell and the one inside the capillary system by any appropriate means. Consequently, ΔPₕ=ρ·g·h_{offset}, where h_{offset} is taken positive if the height of the meniscus inside the capillary system is higher than that of the meniscus inside the sensor cell. Any appropriate height measurement device with a height resolution <<0,1 mm can be used.

Alternatively, the hydrostatic contribution ΔPₕ can also be quantified through an internal calibration method. Internal calibration methods may for example be based on incorporating a capillary system with well-defined geometrical, viscous resistance and/or wetting properties into the hydraulic system of the measuring device at defined height. Also the phenomenon of maximum bubble pressure can be applied. By choosing the appropriate measuring conditions, the hydrostatic contribution can then be obtained directly from the sensor output ΔP adjusted as such, that the viscous pressure drop ΔPᵥ across the hydrodynamic resistance is much larger than that of the capillary pressure ΔP_{L}.

The capillary pressure ΔP_{L} and changes thereof can not only be measured under static, but also under dynamic conditions when a liquid meniscus slowly moves (i.e. advances or recedes) through the capillary system and displaces the second phase, i.e. a gas or another non-miscible liquid. Under dynamic conditions, the sensor output contains in principle also a pressure contribution ΔPᵥ due to viscous stresses inside the capillary system, which are not associated to the presence of the meniscus inside the capillary system. This contribution can be made negligible by reducing the fluid flow D sufficiently. Therefore, we define a critical volume flow rate D^{c}

$${D}^{c} = \frac{π \cdot γ \cdot {a}_{cs}^{3}}{4 \cdot η \cdot {l}_{cs}}$$

with η the liquid viscosity. For D=D^{c}, the viscous and the capillary pressure contributions are of the same order.

When viscous effects have to be eliminated in order to obtain the capillary pressure from the sensor output, this critical flow rate D^{c} determines the desired flow rate D during measurement. In this particular case, preferably D<0,1·D^{c}, more preferred D<0,05·D^{c}, and even more preferred D<0,01·D^{c}.

The viscous pressure contribution ΔPᵥ can be experimentally determined by performing a dynamic measurement (flow rate D known) with a completely filled capillary system attached at the back end to an open liquid reservoir with a (effective) radius ar and filled to a defined liquid level. Preferably aᵣ>3·κ, more preferred aᵣ>5·κ and even more preferred aᵣ>10·κ. This way, the capillary contribution to the liquid pressure difference ΔP is effectively eliminated.

If the sensor cell design fulfills the criteria discussed in this and in the previous section, the influence of changes of the hydrostatic pressure contribution APh on the sensor output are usually negligible. Consequently, when also viscous contributions ΔPᵥ can be neglected, changes of the sensor output ΔP reflect changes of the capillary pressure ΔP_{L}.

For some applications it is useful to perform the measurement when the capillary system is partially filled with the measuring liquid, the other part being filled with another non-miscible liquid (instead of air).

The inventive method for characterizing a capillary system in terms of wettability and geometry is related to the measurement of liquid pressures and changes thereof. The liquid pressure is related to the surface properties and/or to the geometry of the capillary system.

The method for characterization of the surface wettability has a spatial resolution and is therefore suitable to quantify the homogeneity of surfaces inside capillary systems and to characterize the inner geometry of these systems. The invention is also suitable for detection of defects and contamination of surfaces inside capillary systems. These defects and contamination can be localized.

The minimum size of detectable surface spots (i.e. defects or contamination) depends on i) the geometry of the capillary system (i.e. on its effective radius a_{cs}), ii) on local contact angles of the local spot and the surrounding capillary wall (i.e. on θₛ and θ_{cs}, respectively) and iii) on the resolution of the pressure sensor ΔPᵣ. The minimum detectable area Aₘᵢₙ of such spots can be roughly estimated by the equation

$${A}_{min} ≅ {( Δ {P}_{r} \cdot \frac{π \cdot {a}_{cs}^{2}}{γ \cdot ( cos {θ}_{cs} - cos {θ}_{s} )} \cdot )}^{2}$$

EMBEDFor example, with an ΔPᵣ value of 1 Pa, this gives an area Aₘᵢₙ of much less than 0,01 mm² for a hydrophobic spot inside a hydrophilic tubing of 1 mm radius. Hence, by using very sensitive pressure sensors, the described method enables the detection of very small defects or contaminated spots on the capillary surface.EMBED

The very high sensitivity of the pressure measurement inside the liquid phase under static and dynamic conditions according to the invention can also be used for:

characterizing geometrical properties of capillary systems

characterizing the surface properties inside microfluidic devices

monitoring fluid flow inside microfluidic devices

characterizing the surface properties of flat surfaces

monitoring fluid flow through membranes, filters and porous media

determination of the specific surface area of powders

determination of contact angles on powders and inside porous media (and consequently surface free energies)

investigating the dynamics of wetting and spreading of simple and complex (multi-component) liquids

With the device and the method according to the claims, liquid pressures can be very precisely measured. Moreover, very small pressures and changes thereof with a resolution of <10 Pa, preferably <3 Pa, even more preferred of ≦2 Pa can be measured.

This enables the measurement of capillary pressures and therefore the determination of the spatial resolved wetting properties of the inner surfaces and/or the geometrical dimensions of capillary systems with high sensitivity. With the method and device according to the invention, the axial position of liquid meniscus inside the capillary system can be controlled with a high spatial resolution of <<100 μm.

Another object of the invention is a method for characterizing a capillary system concerning viscous resistance providing a pressure measuring device as described above comprising the steps:

a) filling the pressure measuring device with a measuring liquid preferably of known viscosity,

b) pumping this liquid from the pressure measuring device through the capillary system into an open liquid reservoir with constant liquid pressure Pr to fill the capillary system completely with the measuring liquid,

c) measuring the pressure ΔP_{static} (=Pₛ−Pₐₜₘ) under static conditions (no fluid flow),

d) measuring the pressure APdynamic (=Pₛ−Pₐₜₘ) under dynamic conditions preferably as a function of fluid flow rate D,

e) determining the viscous pressure ΔPᵥ=ΔP_{dynamic}-ΔP_{static} preferably as a function of fluid flow rate D,

f) interpretation of the ratios ΔPᵥ/D as measured for the viscous resistance of the capillary system.

By measuring the viscous pressure with the method and device according to the invention, the geometrical dimensions of the capillary system can be investigated.

Further advantages of the method and device according to the invention are:

non-destructive

capillaries may be opaque and of any form and length

only one data point/measurement (instead of complex imaging analysis)

wettability scan across the capillary surface

high sensitivity for local defects along meniscus perimeter

high spatial resolution of wettability in axial direction

detection of very small surface defects and contamination

precise adjustment of volume flow rate, independent of the capillary system properties

handling with small amounts of measuring liquids possible

only temperature control of small gas volume inside sensor cell is necessary

commercially available pressure sensors can be used

The invention is described in the following examples by use of figures without restricting of the scope of the invention.

FIG. 1 shows a schematic drawing of the measuring device.

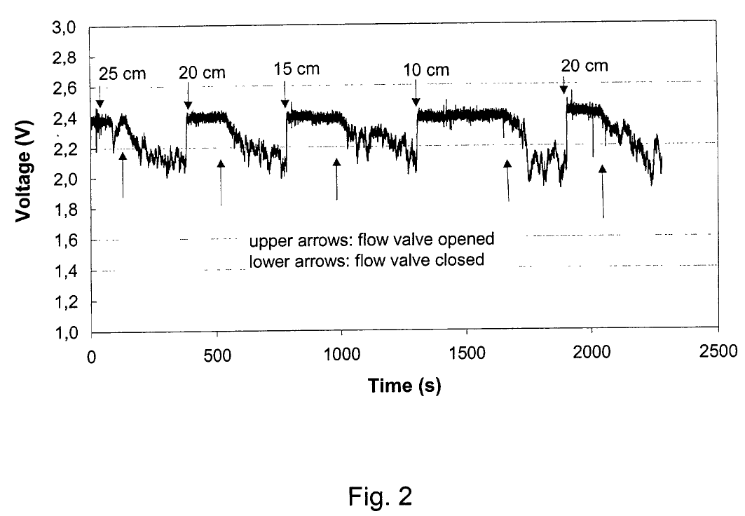

FIG. 2 shows the Investigation of a hydrophobic Teflon tubing (radius r=1,15 mm). Pressure sensor output as a function of time at varying flow rate. Hydrostatic offset: 11 mm H₂O. The numbers in cm indicate the hydrostatic pumping pressure h (cm H₂O. Voltage/pressure conversion: sensitivity 50 Pa/V; zero pressure 2,178V.

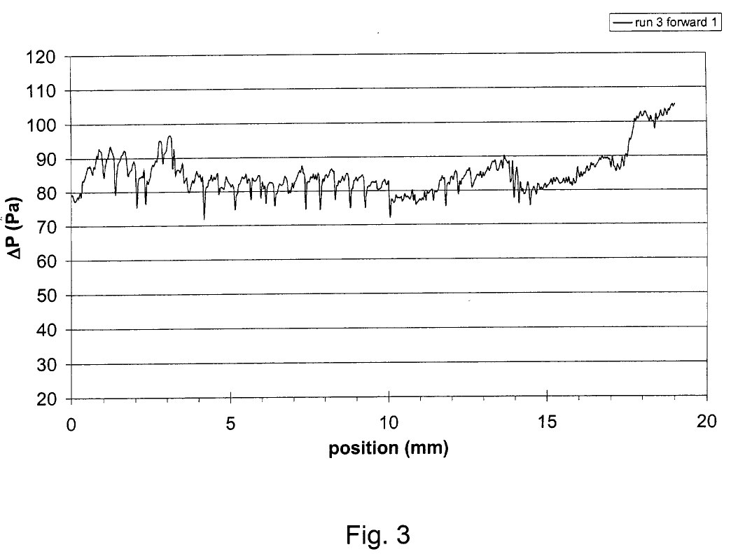

FIG. 3 shows the investigation of a hydrophobic Teflon tubing (radius approximately 1,3 mm). Sensor output as a function of meniscus position inside the Teflon tubing.

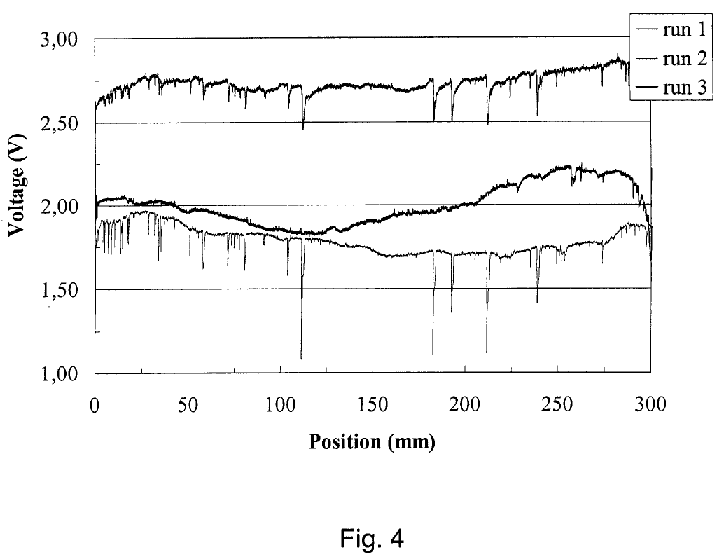

FIG. 4 shows subsequent runs of original and with chloroform washed Teflon tubing (radius r=1,15 mm). Experimental procedure: measurement of untreated tubing (run 1); drying, rinsing with chloroform, drying 10 min with N2; measurement (run 2); drying 10 min with N2; measurement (run 3). Sensor sensitivity: 50 Pa/V. The curves have been shifted for optical purposes.

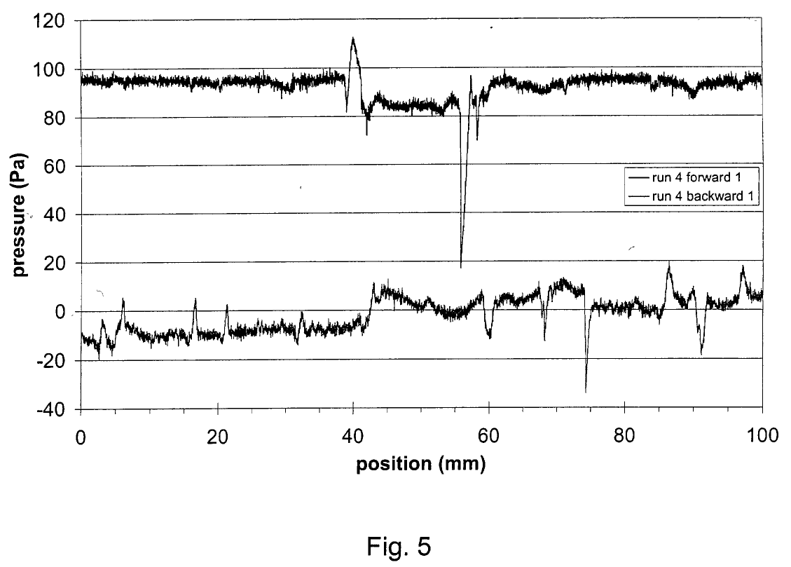

FIG. 5 shows the Investigation of a hydrophobic Teflon tubing with a dilated region (original radius approximately 1,3 mm). Sensor output as a function of meniscus position inside the Teflon tubing.

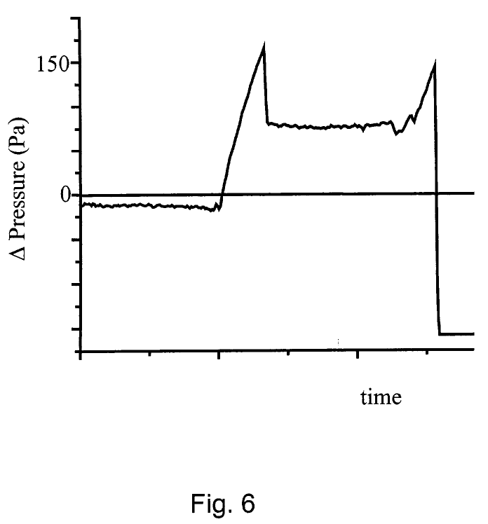

FIG. 6 shows the Characterization of capillary driven flow through a valve.

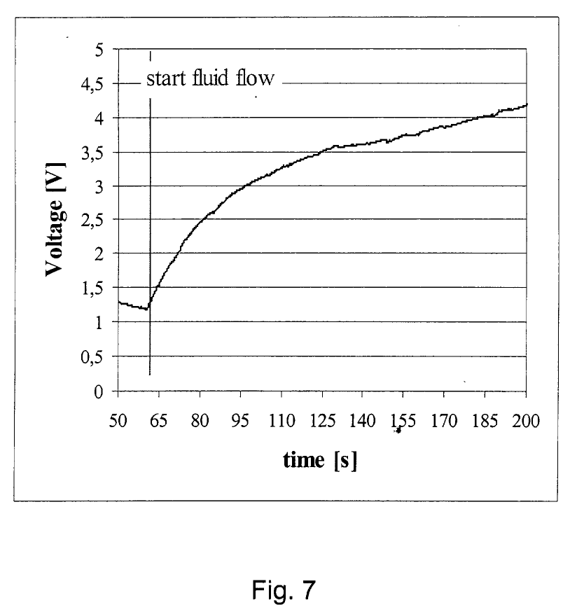

FIG. 7 shows the Characterization of blood flow through a separation pad.

### EXAMPLES

### Example 1

Analysis of a Hydrophobic Tubing

In this example we describe the device parameter and experimental procedure to analyze the static and dynamic wetting behavior of a clean defect free hydrophobic Teflon tubing with a relative large inner diameter of approximately 2 mm. The corresponding pressures to be measured are extremely low (<140 Pa)

A schematic drawing of the measuring device connected to the tubing is given in FIG. 1. To avoid measurements artifacts, major care was taken to position the tubing perfectly horizontally (e.g. no corrugations) and to prevent electrostatic charging of the Teflon tubing and the input of external vibrations (e.g. due to closing doors).

List of system parameters below describes the measurement:

Teflon PFA 450 tubing: inner radius a_{cs}=1,15 mm

measuring liquid: H₂O, surface tension γ=72 mN/m, capillary length κ=2,7 mm

Flow regulator: one 20 mm long capillary with an inner radius a_{fr}=75 μm

sensor cell data: material, glass; radius a_{cell}=10 mm (a_{cell}/κ>3); static water contact angle 0° (contact angle hysteresis H<0,05); thermostated (ΔT<0,1K)

air volume inside sensor cell: Vₐᵢᵣ=1,0 ml (Vₐᵢᵣ^{c}=0,3 ml; Vₐᵢᵣ^{c}<5)

hydrostatic pumping pressure h: 10-25 cm H₂O

Fluid flow rate D: O(1,0 μl/s) (D^{c}=86 μl/s and D/D^{c}<0,05 for l_{cs}=1 m)

average contact line velocity v_{c}: O(240 μm/s)

hydrostatic off set h_{offset}: 11 mm H₂O

Differential pressure sensor PXLA01X0DN (Sensortechnics) with power supply (Delta Elektronika Power Supply ES 030-5): sensitivity 50 Pa/V; zero pressure 2,178V

data acquisition: Agilent 34970 with appropriate software; acquisition rate: 5/s

The following steps are carried out to perform a measurement:

filling the measuring device and connecting tubings with the measuring liquid, e.g. water

Positioning of the meniscus inside sensor cell, using the venting valve

optional: precleaning or conditioning of the tubing

attachment of tubing to device (flow valve closed)

positioning of tubing horizontally

carefully determination of the height difference between tubing and apex of meniscus inside sensor cell. This difference is called the hydrostatic offset h_{offset} (in mm H₂O). The hydrostatic offset is used to adjust the sensed pressure within the measuring range of sensor.

Positioning of the meniscus inside the tubing, using the flow valve

start pressure measurement

open and close flow valve to regulate liquid flow

Some typical results are shown in FIG. 2.

The voltage/pressure conversion can be done by using the characteristic sensor properties. Since under these conditions the sensor output is dominated by the Laplace contribution, the conversion gives directly the Laplace pressure (taking the hydrostatic off set into account). This statement is corroborated by the fact that under dynamic conditions at flow rates corresponding from 10 till 25 mm H₂O pumping pressure (i.e. corresponding to an average contact line velocity v_{c} from 134 till 435 μm, respectively) the voltage output is constant. A pressure resolution of less than 1 Pa is obtained.

The pressure under dynamic is larger than that under static conditions. After closing the flow valve, the flow rate decays slowly down to zero, and hence, the pressure output to its static equilibrium value as well. We obtain a difference of 20 Pa between dynamic and static Laplace pressure.

The dynamic pressure equals roughly 0,2*50+110=120 Pa (i.e. sensor output+hydrostatic offset), which corresponds to a dynamic contact angle of 160°. The static pressure equals roughly 110−0,2*50=100 Pa, which corresponds to a static contact angle of 140°. This value is in good agreement with the one obtained with capillary rise experiments (130°). Hence, this example shows that the measuring device can be used to determine advancing and receding static and dynamic contact angles inside capillary systems with homogeneous surfaces.

### Example 2

Spatial Resolved Analysis of a Contaminated Teflon Tubing.

This example shows that method described above can be used to obtain spatial resolved information about the wetting properties and surface contamination of a capillary system.

Therefore, example 1 is being repeated with a different tubing but of the same type as in example 1. In contrast to example 1, we now measure the pressure only under dynamic conditions with constant hydrostatic pumping pressure h (18 cm) and, therefore, also with constant flow rate D. The resulting spatial resolved pressure profile is depicted in FIG. 3. It shows many small peaks with a typical amplitude approximately 5-10 Pa. Video analysis of the meniscus movement through the tubing shows that these peaks are related to a pinning behavior of the 3-phase contact line. By rinsing the tubing with a suitable solvent and subsequent extensive drying with nitrogen, a smoother pressure profile with larger pressure values are obtained. This shows that the sensor output is sensitive for surface contamination, which, in this particular case, can be removed by a suitable cleaning procedure. Hence, the described procedure can also be used to optimize cleaning conditions.

### Example 3

Magnification of the Pressure Response Due to Surface Defects

This example shows that the method sensitivity for detection and localization of surface defects can be enhanced by a suitable pretreatment of the capillary surface. Therefore, subsequent runs as described in example 2 were carried out with a different piece of Teflon tubing but of the same kind as in example 2. In between the first and second run, a rinsing step with chloroform with subsequent drying with nitrogen has been carried out. Between second and third run, the tubing has only be dried with nitrogen.

FIG. 4 shows that the rinsing step with chloroform makes surface defects visible through the occurrence of peaks at well-defined position. These peaks are not present in the voltage/pressure profile of the original tubing in run 1. In the third run, these peaks can be reproduced with a decrease of intensity.

### Example 4

Investigation of Geometry of Capillary System

This example shows that the measuring device can also be used to characterize the geometry of a capillary system. Therefore, the measurement described in example 2 is being repeated with a different tubing but of the same type as in example 1. Through a blow molding procedure, the radius of the tubing has been locally increased by approximately 20%. Before measurement, the tubing is cleaned in order to remove any possible surface contamination.

The presence of a dilated region in the tubing is clearly reflected in the pressure profile, see FIG. 5. Upon entrance of the meniscus into this region, the pressure increases due to the pinning of the meniscus at this point. Subsequently, the meniscus moves into the dilated region and the pressure drops approximately 20% corresponding to the change of tubing radius. Upon exit of the meniscus out of this region similar but opposite effects occur. The characteristic pressure profile therefore can provide detailed information about the geometry of the capillary system or tubing when wetting inhomogeneities only have a minor influence on the pressure.

Problems related to such wetting inhomogeneities can be overcome by several means. E.g. by pre-filling the capillary device with a wetting liquid with a known and constant pressure difference relative to atmospheric pressure. The measuring liquid is preferably non-wetting and non-miscible with the wetting liquid.

### Example 5

Investigation of Capillary Driven Flow Behavior

This example shows that the measuring device can also be used to characterize and quantify flow behavior in capillary devices, in which the liquid flow should be driven by capillary forces.

Therefore, the flow through a liquid valve of capillary dimensions (bore dimensions: length 1 cm long, radius 560 μm, volume 10 μl) has been investigated according to the procedure described in example 1. However, the hydrostatic pumping pressure h (25 cm H₂O) and flow regulator (120 mm long capillary with an inner radius af=75 μm) were changed to give a constant volume flow D of 0,27 μl/s.

The resulting pressure profile in FIG. 6 shows a pressure increase when the liquid is forced to enter the valve. Upon exit the valve, the pressure increases first, subsequently it decreases. This means that in absence of any external applied pressure, this valve will not fill spontaneously when it comes into in contact with water. In fact, here the capillary forces resist the filling of the valve. The external applied pressure, which is necessary to overcome the capillary forces and to fill this valve, can be quantified. In this particular case approximately 150 Pa.

### Example 6

Investigation Flow Through Porous System

This example shows that the measuring device can also be used to characterize the liquid flow through porous systems, e.g. filters. The advantages of this method lies in the fact that one can work with very small amounts of liquid/sample and that only very small pressures have to be applied to drive the liquid flow. The latter is special advantageous, since one can also work with very fragile porous systems without distorting their structure under practice relevant conditions.

To illustrate this, the flow of a blood sample at constant flow rate D trough a filter or separation pad inside a capillary system has been investigated. The pressure needed to drive this constant flow could be determined by connecting this capillary system to the measuring device filled with water as driving liquid. To prevent dilution effects, a large air segment has been introduced into the system to separate the blood sample from the driving liquid. The same flow regulator as in the previous example was used, a hydrostatic pumping pressure h of 5 cm H₂O was applied.

The resulting pressure profile in FIG. 7 shows a slow pressure increase when the blood sample flows through the separation pad. Since the meniscus penetrates nearly instantaneously through the filter after starting the fluid flow, the slow pressure increase is dominated by the viscous flow contribution. Capillary effects can be neglected in this particular case. Hence, the pressure increase indicates clogging of the pad with blood cells, since with water as sample this effect is not being observed. This clogging phenomenon was corroborated by light microscopy.

### Example 7

Investigation Offlat Surfaces

The spatial resolved wetting behavior of flat surfaces, e.g. oxidized silicon surfaces, can be investigated with the measuring device if these surface can be introduced into a capillary system, which can be investigated according to the procedures described in the previous examples. Therefore, a slit capillary of width a, height b and length l can be used. Hence, the slit capillary contains two flat walls (1 and 2) of width a and length l. The construction of the slit capillary should be now designed as such, that these flat walls can be represented by the flat surface(s) to be investigated. The investigation can be carried out with one or two (preferably identical) surfaces. If only one flat surface has to be investigated, this surface can be split in two parts and used as wall 1 and wall 2. If the surface is only used for one wall (say 1), the other wall (2) has to be represented by a flat homogeneous surface with known wetting properties. This holds also for the properties of the two other capillary walls (3 and 4) of width b and length l. An appropriate connection between slit capillary and measuring device to enable the measurement similar to example 1 has to be made.

For the investigation of an oxidized silicon wafer (static water contact angle 40°), two parts are cut out of the wafer, being used as wall 1 and 2 (a=10 mm, l=100 mm). The other walls 3 and 4 are made out of PTFE (static water contact angle 110°, b=0,5 mm, l=100 mm). The hydrostatic pumping pressure h (25 cm H₂O) and flow regulator (120 mm long capillary with an inner radius a_{fr}=75 μm) are changed to give a constant volume flow D of 0,2711/s. Hence, the measurement are carried out with water as measurement liquid according to the procedure described in example 5. Equation 1 is used to interpret the pressure profile in terms of wetting behavior of the oxidized silicon surface.

### Example 8

Investigation of Wetting Properties of Particles

Diggins et al. (Colloids and Surfaces, 44, 1990, 299-313) describe an experimental apparatus for the determination of powder wettability. Using White's thermodynamic approach (Journal of Colloid and Interface Science, 90, 1982, 536), they obtain the macroscopic contact angle and the specific surface area of the powder. The principle of Diggins technique is based on the measurement of the equilibrium capillary pressure in a carefully packed bed of particles in an air tight column with a valve at the top. The liquid under study is allowed to spontaneously enter the powder bed from the bottom of the column. After some time, the top valve is closed. The liquid still continues to rise until the overpressure in the top part of the column exactly compensates the capillary pressure (taking hydrostatic contributions into account). A pressure transducer detects the overpressure in the top part of the column, from which the capillary pressure can be deduced. According to Diggins et al., the principle of measurement sets practical limitations as to the degree of polydispersity and the fineness of the powders used.

However, these limitations can be overcome by avoiding the overpressure in the top part of the column (top valve open) and by direct measurement of the pressure inside the measuring liquid using the measurement device described in this application.

To determine the wetting properties of quartz particles (average particle diameter approximately 100 μm), a column (radius 1 cm) is filled with the dry quartz powder, whilst gently tapping to ensure uniformity of packing. The bottom part of the column, which tapers to a narrow capillary, is connected to the measurement device as described in example 1. A hydrostatic pumping pressure h=25 cm of the measuring liquid and a 120 mm long capillary with an inner radius a_{fr}=75 μm as flow regulator is used. One experiment is carried out with water as measuring liquid, another with cyclohexane. Different packed beds are used for the different liquids. The pressure is measured under static conditions (no fluid flow), according to the principles of the procedure described in example 1. The measurement are repeated at a different position of the macroscopic meniscus inside the particle bed after opening the fluid valve for a certain time and closing it again. The capillary pressure in the packed bed is relative large, O(0.1 bar). Therefore as differential pressure sensor, the 144SB001D-PCB of Sensortechnics is used (operating pressure 0-1 bar). Interpretation of the data to obtain the static (water) contact angle on and the specific surface area of the particles is carried out according to the theory of White.

1. Pressure measuring device for characterizing the capillary pressure and/or wettability of a capillary system in terms of wettability at a resolution of at least 100 Pa, preferably at least 10 Pa, comprising
A) a liquid pump for pumping a measuring liquid through the capillary system,
B) a pressure sensor to measure the pressure of the liquid, and
C) a tubing system connecting the liquid pump, and the pressure sensor cell with a capillary system.

2. Pressure measuring device according to claim 1, characterized in that the pump is a hydrostatic pump.

3. Pressure measuring device according to claim 1 or 2, characterized in that the hydrostatic pump comprises a hydrostatic column, a flow valve and a flow regulator.

4. Pressure measuring device according to claim 3, characterized in that the pressure sensor is connected via a air tight pressure sensor cell to the tubing between flow regulator and capillary system.

5. Pressure measuring device according to any of claims 1-4, characterized in that the pressure sensor cell is fully filled with measuring liquid.

6. Pressure measuring device according to any of claims 1-4, characterized in that the pressure sensor cell is partially filled with measuring (such that there is a liquid/gas interface inside the sensor cell).

7. Pressure measuring device according to any of claims 1-6, characterized in that pressure sensor measures the difference between the sensor cell pressure and the atmospheric pressure.

8. Pressure measuring device according to any of claims 1-6, characterized in that the sensor cell inner wall is modified so that the static contact angle of the measuring liquid with the sensor cell inner wall is about 90°.

9. Pressure measuring device according to any of claims 1-8, characterized in that the (effective) radius of the sensor cell a_{cell} should be preferably adjusted as such, that preferably
$${a}_{cell} > 0 , 2 \cdot \frac{γ}{Δ {P}_{r}}$$
more preferred
$${a}_{cell} > 2 \cdot \frac{γ}{Δ {P}_{r}}$$
and
even more preferred
$${a}_{cell} > 20 \cdot \frac{γ}{Δ {P}_{r}}$$
with γ the surface tension of the measuring liquid and ΔPᵣ the desired pressure solution.

10. Pressure measuring device according to any of claims 1-9, characterized in that the a_{cell} the (effective) radius of the sensor cell a_{cell} should be preferably adjusted as such, that the capillary length κ defined by κ=\sqrt{γ/ρ·g}, where γ and ρ are the surface tension and the density of the measuring liquid, respectively, and g the gravity constant. Preferably a_{cell}>κ, more preferred a_{cell}>3·κ and even more preferred a_{cell}>5·κ.

11. Pressure measuring device according to any of claims 1-10, characterized in that the sensor cell is thermostated.

12. Pressure measuring device according to any of claims 1-11, characterized in that a flow valve is positioned between the liquid pump and the pressure sensor.

13. Method for characterizing a capillary system concerning capillary pressure and/or wettability comprising the steps providing a pressure measuring device according to one of the claims 1 to 12,
a) filling the pressure measuring device with a measuring liquid,
b) pumping this liquid from the pressure measuring device through the capillary system to fill or empty the capillary system with the measuring liquid and displacing a second phase, e.g. air, in the capillary system,
c) measuring the pressure difference ΔP=Pₛ−Pₐₜₘ (with Pₛ the sensor cell pressure and Pₐₜₘ the atmospheric pressure) under static or dynamic conditions,
d) eventually measuring or determining the pressure P₂ of the second phase if P₂ is Pₐₜₘ which will be displaced when the measuring liquid flows through the capillary system,
e) measuring the hydrostatic contribution ΔPₕ,
f) measuring or determining the viscous contribution ΔPᵥ,
g) determining the capillary pressure ΔP_{L} according to formula (II),
ΔP_{L}=ΔPₕ+ΔPᵥ−ΔP+(P₂−Pₐₜₘ) (II)
h) interpretation of the capillary pressure APL in terms of wettability by using equation (I)
$$Δ {P}_{L} = \frac{γ \cdot {\int }_{cl}^{} cos {θ}_{l} ⅆ x}{A} \qquad ( I )$$

14. Method according to claim 13, characterized in that the diameter and length of a flow regulator is chosen, so that the pressure drop across the flow regulator is larger than the sum of the absolute value of the capillary pressure APL and the pressure drop APf due to the viscous resistance across the tubing system and the capillary system.

15. Method according to claim 13 or 14, characterized in that after step b) the liquid/gas interface of the liquid (meniscus) in the capillary system is moved forward and backward by further pumping and that after one or more movements of the meniscus the steps c) to e) are repeated.

16. Method according to any of claims 13-15, characterized in that the air volume Vₐᵢᵣ inside the sensor cell is chosen as such that preferably Vₐᵢᵣ<5·Vₐᵢᵣ^{c}, more preferred Vₐᵢᵣ<1·Vₐᵢᵣ^{c}, and even more preferred Vₐᵢᵣ<0,1·Vₐᵢᵣ^{c}, with Vₐᵢᵣ^{c} a system dependent critical volume as defined above.

17. Method according to any of claims 13-16, characterized in that before step b) a calibration procedure for the hydrostatic system is introduced based on a maximum bubble pressure measurement, or on a pressure measurement at defined flow rate through a high hydrodynamic resistance of known value at defined height, or on a measurement of the capillary pressure inside a capillary system with known geometrical and wetting properties at defined height.

18. Method according to any of claims 13-17 characterized in that a powder of a chemical compound is placed in the capillary system and the combined properties of powder and capillary are determined.

19. Method for characterizing a capillary system concerning viscous resistance providing a pressure measuring device according to one of the claims 1 to 12 comprising the steps:
a) filling the pressure measuring device with a measuring liquid preferably of known viscosity,
b) pumping this liquid from the pressure measuring device through the capillary system into an open liquid reservoir with constant liquid pressure Pᵣ to fill the capillary system completely with the measuring liquid,
c) measuring the pressure ΔP_{static} (=Pₛ-Pₐₜₘ) under static conditions (no fluid flow),
d) measuring the pressure ΔP_{dynamic} (=Pₛ-Pₐₜₘ) under dynamic conditions preferably as a function of fluid flow rate D,
e) determining the viscous pressure ΔPᵥ=ΔP_{dynamic}-ΔP_{static} preferably as a function of fluid flow rate D,
f) interpretation of the ratios ΔPᵥ/D as measured for the viscous resistance of the capillary system.
